(19) United States
(12) Patent Application Publication
(10) Pub. No.: US 2026/0064162 A1
(43) Pub. Date: Mar. 5, 2026

(54) ELECTRONIC DEVICE

(71) Applicant: Acer Incorporated, New Taipei City (TW)

(72) Inventors: Chun-Hung Wen, New Taipei City (TW); Hui-Ping Sun, New Taipei City (TW); Chun-Hsien Chen, New Taipei City (TW); Jui-Yi Yu, New Taipei City (TW); Hua-Feng Hsieh, New Taipei City (TW); Yen-Chou Chueh, New Taipei City (TW)

(73) Assignee: Acer Incorporated, New Taipei City (TW)

(21) Appl. No.: 19/192,345

(22) Filed: Apr. 29, 2025

(30) Foreign Application Priority Data
Aug. 29, 2024 (TW) 113132515

(51) Int. Cl. G06F 1/16

(52) U.S. Cl. CPC G06F 1/1669; G06F 1/1616; G06F 1/1656

(57) ABSTRACT

An electronic device that includes a housing, a positioning structure and an input module is provided. The housing has a top, a mounting region located on the top, a bottom relative to the top, and a disassembling region located on the bottom. The positioning structure corresponding to the disassembling region is disposed on an inside of the housing. The input module is detachably mounted on the mounting region and is provided with a positioning post. The positioning post is inserted into the inside of the housing from the mounting region to engage with the positioning structure in order to mount and fix the input module on the housing. An engagement restriction of the positioning structure to the positioning post is adapted to be released through an auxiliary tool to detach the input module from the housing.

### CROSS-REFERENCE TO RELATED APPLICATION

This application claims the priority benefit of Taiwan application serial no. 113132515, filed on Aug. 29, 2024. The entirety of the above-mentioned patent application is hereby incorporated by reference herein and made a part of this specification.

### BACKGROUND

### Technical Field

The disclosure relates to an electronic device, and in particular to an electronic device with a quick disassembly design.

### Description of Related Art

A common notebook computer is composed of a display and a body that are pivotally connected to each other, and the body is mostly provided with a keyboard and a touchpad to facilitate users to input commands, move pages, or execute other operating functions through the keyboard or the touchpad. Generally speaking, the keyboard and the touchpad are screwed and fixed to a housing through multiple screws. During the process of disassembling or assembling the keyboard and the touchpad, users have to use a screwdriver to loosen or tighten the screws. The process is not only time-consuming but also labor-intensive.

### SUMMARY

The disclosure provides an electronic device that facilitates users to quickly disassemble or assemble an input module.

The disclosure proposes an electronic device that includes a housing, a positioning structure and an input module. The housing has a top, a mounting region located on the top, a bottom relative to the top, and a disassembling region located on the bottom. The positioning structure corresponding to the disassembling region is disposed on an inside of the housing. The input module is detachably mounted on the mounting region and is provided with a positioning post. The positioning post is inserted into the inside of the housing from the mounting region to engage with the positioning structure in order to mount and fix the input module on the housing. An engagement restriction of the positioning structure to the positioning post is adapted to be released through an auxiliary tool to detach the input module from the housing.

Based on the above, the electronic device of the disclosure integrates a quick-detaching engaging mechanism into a disassembly-assembly design of the input module. Not only quick disassembly or assembly of the input module by users is facilitated, but also the use of screws is decreased in order to reduce manufacturing costs and decrease resource consumption.

In order to make the features and advantages of the disclosure more comprehensible, the following examples are given and described in detail with the accompanying drawings as follows.

### BRIEF DESCRIPTION OF THE DRAWINGS

FIG. 1A and FIG. 1B are schematic views of an electronic device from two different viewing angles according to an embodiment of the disclosure.

FIG. 1C is a schematic view of the keyboard detaching the housing in FIG. 1B.

FIG. 1D is an enlarged schematic view of an internal structure in region 1D in FIG. 1A.

FIG. 1E is a schematic view of the keyboard detaching the housing in FIG. 1D.

FIG. 2A is a partial cross-sectional enlarged schematic view along line segment 2A-2A in FIG. 1B.

FIG. 2B is a schematic view of the keyboard detaching the housing in FIG. 2A.

### DESCRIPTION OF THE EMBODIMENTS

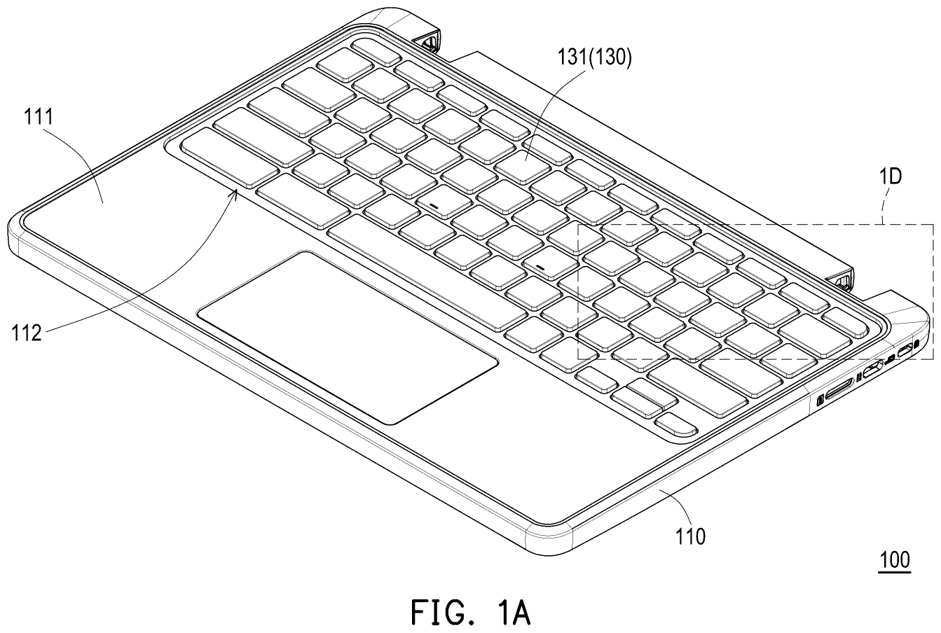

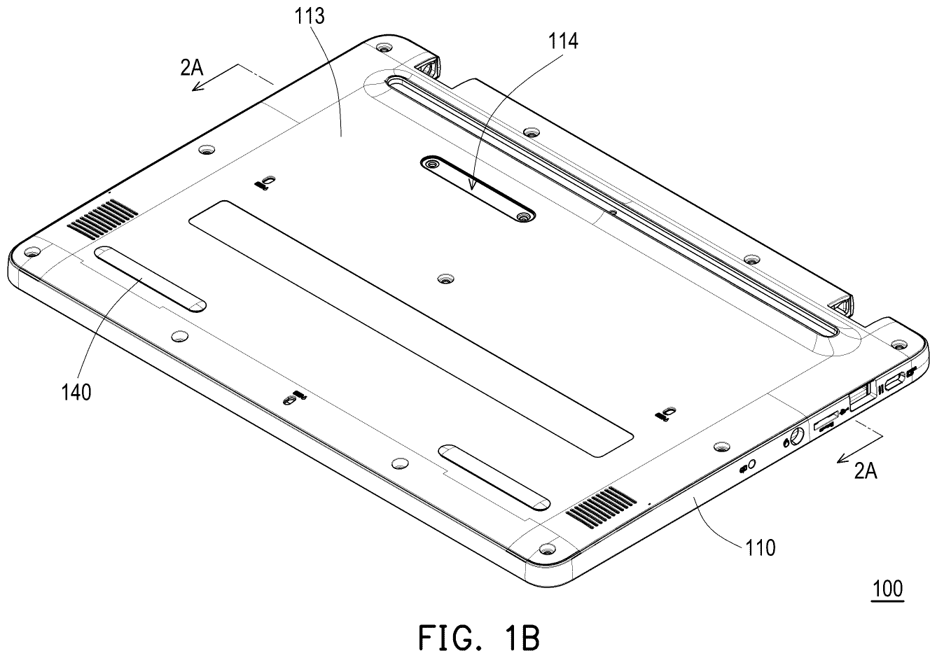

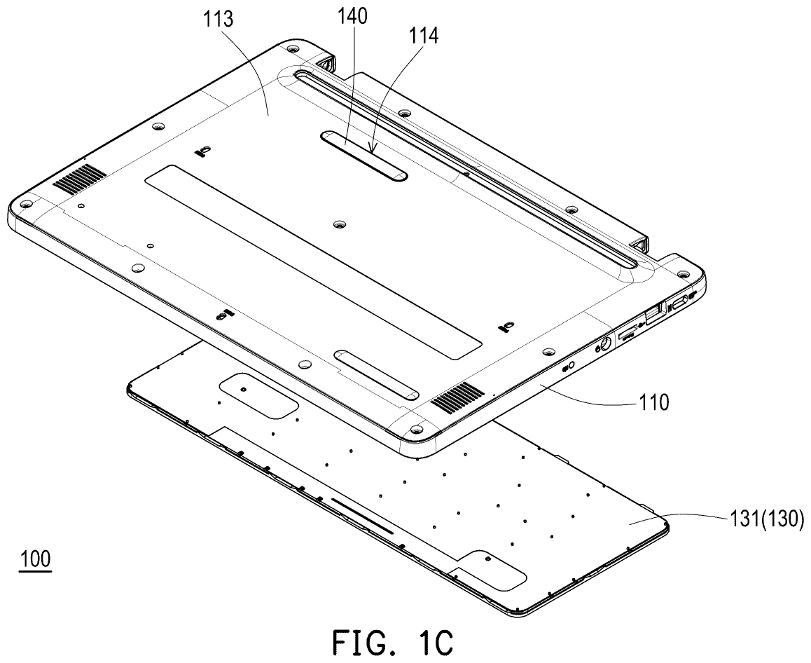

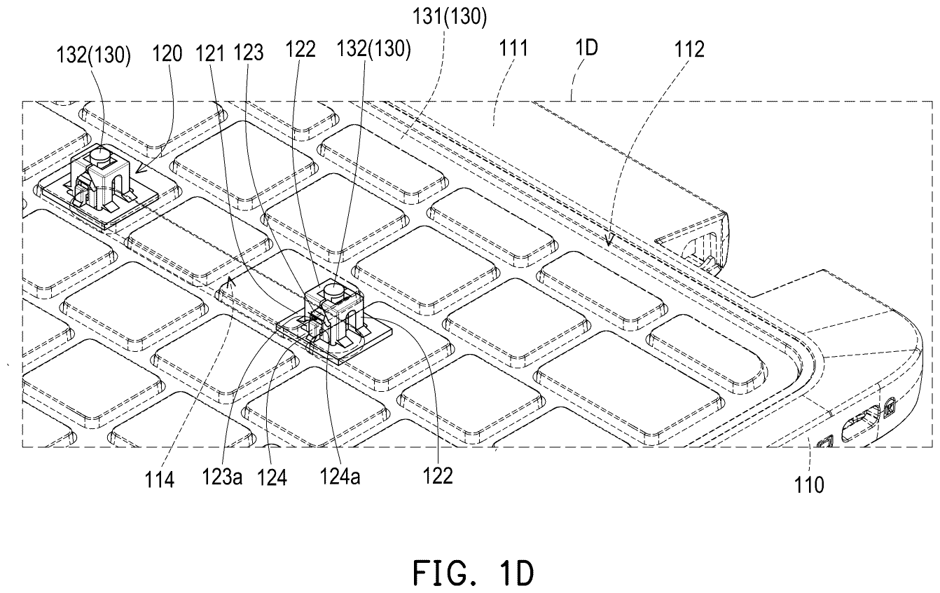

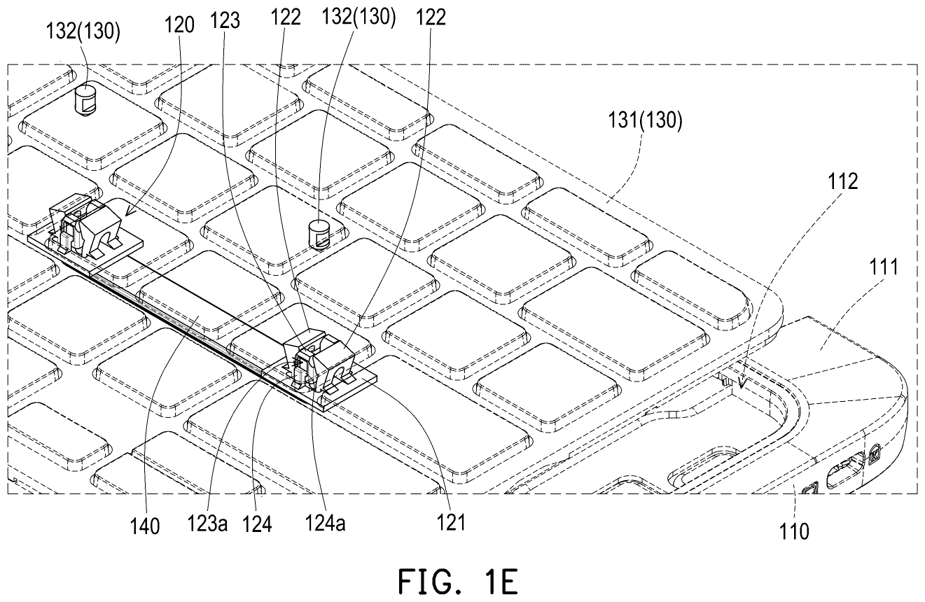

FIG. 1A and FIG. 1B are schematic views of an electronic device from two different viewing angles according to an embodiment of the disclosure. FIG. 1C is a schematic view of the keyboard detaching the housing in FIG. 1B. FIG. 1D is an enlarged schematic view of an internal structure in region 1D in FIG. 1A. FIG. 1E is a schematic view of the keyboard detaching the housing in FIG. 1D. In FIG. 1D and FIG. 1E, a housing 110 and a body 131 of an input module 130 are illustrated as dotted lines to clearly show a relative relationship between a positioning structure 120 and a positioning post 132 of the input module 130.

First, please refer to FIG. 1A, FIG. 1B and FIG. 1D. In the embodiment, an electronic device 100 may be a body in a notebook computer that is pivotally connected to a display, and includes a housing 110, a positioning structure 120 and an input module 130. In detail, the housing 110 has a top 111, a mounting region 112 located on the top 111, a bottom 113 relative to the top 111, and a disassembling region 114 located on the bottom 113. The positioning structure 120 corresponding to the disassembling region 114 is disposed on an inside of the housing 110, and the input module 130 is detachably mounted on the mounting region 112.

The input module 130 may include the body 131 and the positioning post 132 protruding from the body 131. The positioning post 132 is inserted into the housing 110 from the mounting region 112 to engage with the positioning structure 120 in order to mount and fix the input module 130 on the housing 110. For example, the input module 130 may be a keyboard, but it is not limited thereto. In other examples, the input module 130 may be a touch panel. In addition, the number of the positioning structure 120 may be disposed as two, and the number of the positioning post 132 may also be correspondingly disposed as two, but it is not limited thereto. In other examples, the number of the positioning structure 120 and the number of the positioning post 132 may be increased or decreased according to design requirements.

Next, please refer to FIG. 1A and FIG. 1B. In the embodiment, the electronic device 100 further includes a cushion 140. In detail, the cushion 140 is detachably disposed on the bottom 113 of the housing 110. In a condition where the input module 130 is mounted and fixed on the housing 110, the cushion 140 is located outside the disassembling region 114.

Then, please refer to FIG. 1B to FIG. 1E. The cushion 140 is mounted on the disassembling region 114 after being detached from the bottom 113 of the housing 110. The cushion 140 may release an engagement restriction of the positioning structure 120 to the positioning post 132 to facilitate users to detach the input module 130 from the housing 110. That is to say, the cushion 140 may be used as an auxiliary tool for disassembling the input module 130, but it is not limited thereto. In other examples, the auxiliary tool may be a screwdriver, a stylus, a pencil, a ball pen, or other adapted tools.

In contrast, when a user mounts the input module 130 to the mounting region 112 of the housing 110, the positioning post 132 of the input module 130 may quickly engage with the positioning structure 120 in order to mount and fix the input module 130 on the housing 110. On the other hand, the positioning post 132 may move the cushion 140 mounted on the disassembling region 114 for the cushion 140 to be removed from the disassembling region 114, and for the user to mount the cushion 140 back to the original position shown in FIG. 1B.

Since the electronic device 100 integrates a quick-detaching engaging mechanism into a disassembly-assembly design of the input module 130, not only quick disassembly or assembly of the input module 130 by users is facilitated, but also the use of screws is decreased in order to reduce manufacturing costs and decrease resource consumption.

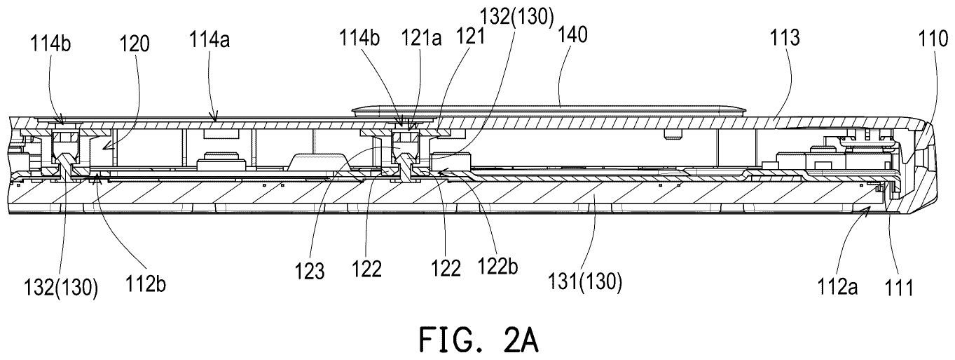

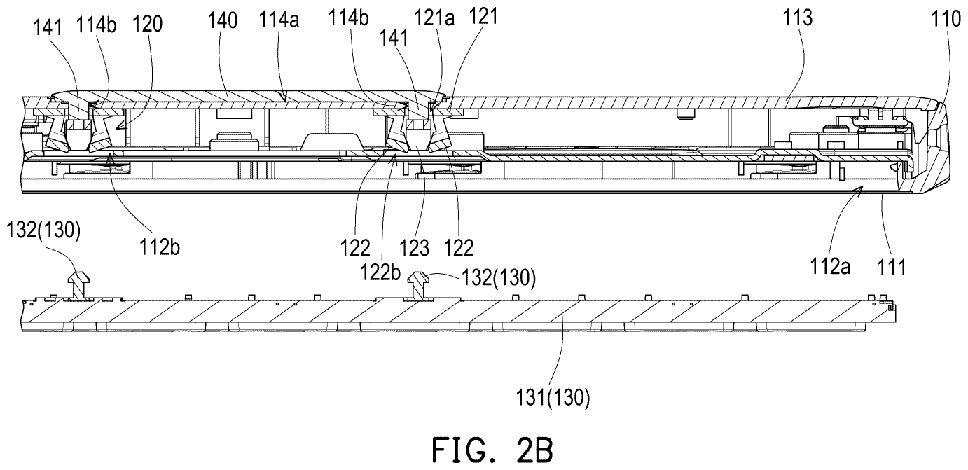

FIG. 2A is a partial cross-sectional enlarged schematic view along line segment 2A-2A in FIG. 1B. FIG. 2B is a schematic view of the keyboard detaching the housing in FIG. 2A. Please refer to FIG. 1D to FIG. 2B. In the embodiment, a projection of the mounting region 112 and a projection of the disassembling region 114 overlap. The mounting region 112 includes a recess 112a and a perforation 112b, and the recess 112a communicates with the inside of the housing 110 through the perforation 112b. In addition, the disassembling region 114 includes a recess 114a and a perforation 114b, and the recess 114a communicates with the inside of the housing 110 through the perforation 114b. For example, the number of the perforation 112b of the mounting region 112 and the number of the perforation 114b of the disassembling region 114 match the number of the positioning structure 120.

In detail, the positioning structure 120 is aligned with the perforation 112b of the mounting region 112 and the perforation 114b of the disassembly region 114, and the perforation 112b of the mounting region 112 and the perforation 114b of the disassembly region 114 are respectively located on opposite sides of the positioning structure 120. As shown in FIG. 2A, the body 131 of the input module 130 is adapted to be accommodated in the recess 112a of the mounting region 112, and the positioning post 132 is inserted into the inside of the housing 110 through the perforation 112b of the mounting region 112 to engage with the positioning structure 120. As shown in FIG. 2B, an auxiliary tool is adapted to be accommodated in the recess 114a of the disassembling region 114, and at least part of the auxiliary tool is inserted into the inside of the housing 110 through the perforation 114b of the disassembling region 114 to drive at least part of the positioning structure 120 to expand in order to release the engagement restriction of the positioning structure 120 to the positioning post 132.

As shown in FIG. 1C, FIG. 1E and FIG. 2B, the cushion 140 is used as the auxiliary tool for disassembling the input module 130 and is provided with a protrusion 141. When a user mounts the cushion 140 on the disassembling region 114, the protrusion 141 is inserted into the housing 110 from the disassembling region 114 and drives at least part of the positioning structure 120 to expand to release the engagement restriction of the positioning structure 120 to the positioning post 132. Furthermore, when the cushion 140 is mounted on the disassembling region 114, the cushion 140 is accommodated in the recess 114a of the disassembling region 114, and the protrusion 141 is inserted into the inside of the housing 110 through the perforation 114b of the disassembling region 114 to drive at least part of the positioning structure 120 to expand in order to release the engagement restriction of the positioning structure 120 to the positioning post 132. For example, the number of the protrusion 141 matches the number of the positioning structure 120.

Please refer to FIG. 1D to FIG. 2B. In the embodiment, the positioning structure 120 includes a bottom plate 121, two elastic arms 122 disposed in pairs, and a driven member 123. The bottom plate 121 is fixed on the inside of the housing 110 and has a perforation 121a. The perforation 121a of the bottom plate 121 is aligned with the perforation 114b of the disassembling region 114 and communicates with the perforation 114b of the disassembling region 114. On the other hand, the two elastic arms 122 are connected to the bottom plate 121. The driven member 123 contacts the two elastic arms 122 and is slidably disposed between the two elastic arms 122.

As shown in FIG. 1D and FIG. 2A, the positioning post 132 of the input module 130 is inserted into the inside of the housing 110 through the perforation 112b of the mounting region 112, and further inserted between the two elastic arms 122 in order to be engaged between the two elastic arms 122. As shown in FIG. 1E and FIG. 2B, when a user mounts the cushion 140 on the disassembling region 114, the protrusion 141 is inserted into the inside of the housing 110 through the perforation 114b of the disassembling region 114, and further inserted between the two elastic arms 122 to move the driven member 123 for the driven member 123 to push the two elastic arms 122 in order to increase a gap between the two elastic arms 122 and release an engagement restriction of the two elastic arms 122 to the positioning post 132.

As shown in FIG. 2B, the perforation 121a of the bottom plate 121 is located between the two elastic arms 122 and is aligned with the driven member 123. When a user mounts the cushion 140 on the disassembling region 114, the protrusion 141 sequentially passes through the perforation 114b of the disassembling region 114 and the perforation 121a of the bottom plate 121 to be inserted into the inside of the housing 110, and further inserted between the two elastic arms 122.

As shown in FIG. 1D and FIG. 2A, the two elastic arms 122 both have a top end away from the bottom plate 121 and an engaging protrusion protruding from the top end, and the two engaging protrusions of the two elastic arms 122 face each other. On the other hand, the positioning post 132 has a post connected to the body 131 and a head connected to the post. The head of the positioning post 132 is far away from the body 131, and an outer diameter of the head of the positioning post 132 is larger than an outer diameter of the post of the positioning post 132. When the positioning post 132 is inserted between the two elastic arms 122, the head of the positioning post 132 passes between the two engaging protrusions of the two elastic arms 122, and the post of the positioning post 132 is inserted between the two engaging protrusions of the two elastic arms 122. Since a gap between the two engaging protrusions of the two elastic arms 122 is smaller than the outer diameter of the head of the positioning post 132, the two engaging protrusions of the two elastic arms 122 may generate structural interference to the head of the positioning post 132 to prevent the positioning post 132 from accidentally breaking away from positioning structure 120.

As shown in FIG. 1E and FIG. 2B, when the protrusion 141 is inserted between the two elastic arms 122, the protrusion 141 moves the driven member 123, and the two elastic arms 122 are elastically deformed under the push of the driven member 123, so that the two engaging protrusions of the two elastic arms 122 move away from each other to increase the gap between the two engaging protrusions of the two elastic arms 122. For example, the gap between the two engaging protrusions of the two elastic arms 122 is increased to be greater than or equal to the head of the positioning post 132 to allow the head of the positioning post 132 to move through the gap between the two engaging protrusions of the two elastic arms 122 and break away from the positioning structure 120.

As shown in FIG. 1D and FIG. 1E, the positioning structure 120 further includes a guiding component 124. The guiding component 124 is connected to the bottom plate 121 and is provided with a guiding protrusion 124a. Correspondingly, the driven member 123 corresponding to the guiding protrusion 124a is provided with a guiding sliding groove 123a, and the guiding protrusion 124a is slidably disposed in the guiding sliding groove 123a. Through the compatibility of the guiding protrusion 124a and the guiding sliding groove 123a, the driven member 123 may steadily slide back and forth along a direction perpendicular to the bottom plate 121.

In summary, in the electronic device of the disclosure, the input module is provided with the positioning post, and the positioning structure corresponding to the positioning post is disposed on the inside of the housing. When a user mounts the input module on the mounting region of the top of the housing, the positioning post may quickly engage with the positioning structure in order to mount and fix the input module on the housing. In contrast, the user may mount or insert an auxiliary tool (such as a cushion or other readily available tools) into the disassembling region of the bottom of the housing to release the engagement restriction of the positioning structure to the positioning post in order to quickly detach the input module from the housing. That is to say, the electronic device of the disclosure integrates a quick-detaching engaging mechanism into the disassembly-assembly design of the input module. Not only quick disassembly or assembly of the input module by users is facilitated, but also the use of screws is decreased in order to reduce manufacturing costs and decrease resource consumption.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. An electronic device, comprising:
a housing, having a top, a mounting region located on the top, a bottom relative to the top, and a disassembling region located on the bottom;
a positioning structure, corresponding to the disassembling region disposed on an inside of the housing; and
an input module, detachably mounted on the mounting region, wherein the input module is provided with a positioning post, and the positioning post is inserted into the inside of the housing from the mounting region to engage with the positioning structure in order to mount and fix the input module on the housing, wherein
an engagement restriction of the positioning structure to the positioning post is adapted to be released through an auxiliary tool to detach the input module from the housing.

2. The electronic device according to claim 1, further comprising:
a cushion, detachably disposed on the bottom of the housing and provided with a protrusion, wherein the cushion is adapted to be the auxiliary tool, the cushion is mounted on the disassembling region after being detached from the bottom of the housing, and the protrusion is inserted into the inside of the housing from the disassembling region and drives at least part of the positioning structure to expand to release the engagement restriction of the positioning structure to the positioning post.

3. The electronic device according to claim 1, wherein the positioning structure comprises:
a bottom plate, fixed on the inside of the housing;
two elastic arms disposed in pairs, connected to the bottom plate, wherein the positioning post that is inserted into the inside of the housing from the mounting region is further inserted between the two elastic arms and engaged between the two elastic arms; and
a driven member, contacting the two elastic arms and slidably disposed between the two elastic arms, wherein at least part of the auxiliary tool is adapted to be inserted into the inside of the housing from the disassembling region and further inserted between the two elastic arms to move the driven member, so that the driven member pushes the two elastic arms in order to increase a gap between the two elastic arms and release an engagement restriction of the two elastic arms to the positioning post.

4. The electronic device according to claim 3, wherein the positioning structure further comprises:
a guiding component, connected to the bottom plate and provided with a guiding protrusion, wherein the driven member corresponding to the guiding protrusion is provided with a guiding sliding groove, and the guiding protrusion is slidably disposed in the guiding sliding groove.

5. The electronic device according to claim 3, wherein the bottom plate is provided with a perforation that communicates with the disassembling region, and the perforation is located between the two elastic arms, the perforation is aligned with the driven member, and the at least part of the auxiliary tool is adapted to be inserted into the inside of the housing from the disassembling region and further inserted between the two elastic arms through the perforation.

6. The electronic device according to claim 1, wherein the mounting region comprises a recess and a perforation, the recess communicates with the inside of the housing through the perforation, and the positioning structure is aligned with the perforation.

7. The electronic device according to claim 6, wherein the input module is adapted to be accommodated in the recess, and the positioning post is inserted into the inside of the housing through the perforation to engage with the positioning structure.

8. The electronic device according to claim 1, wherein the disassembling region comprises a recess and a perforation, the recess communicates with the inside of the housing through the perforation, and the positioning structure is aligned with the perforation.

9. The electronic device according to claim 8, wherein the auxiliary tool is adapted to be accommodated in the recess, and at least part of the auxiliary tool is inserted into the inside of the housing through the perforation to drive at least part of the positioning structure to expand in order to release the engagement restriction of the positioning structure to the positioning post.

10. The electronic device according to claim 1, wherein a projection of the mounting region and a projection of the disassembling region overlap.
